(19) United States
(12) Patent Application Publication
(10) Pub. No.: US 2022/0024336 A1
(43) Pub. Date: Jan. 27, 2022

(54) CONTROL METHOD, CONTROL SYSTEM, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Yuuki HIROSE, Osaka (JP); Tetsuji FUCHIKAMI, Osaka (JP); Motoji OHMORI, Osaka (JP)

(21) Appl. No.: 17/497,304

(22) Filed: Oct. 8, 2021

Related U.S. Application Data
(63) Continuation of application No. PCT/JP2020/016446, filed on Apr. 14, 2020.
(60) Provisional application No. 62/834,740, filed on Apr. 16, 2019.

(51) Int. Cl. B60L 53/62; G07C 5/00; B60L 58/12

(52) U.S. Cl. CPC B60L 53/62; G07C 5/008; G06Q 10/02; B60L 2200/12; B60L 58/12

(57) ABSTRACT

A control method includes obtaining, from a terminal, reservation information including use start date and time of an electric-powered vehicle that a first user hopes to use; obtaining an amount of remaining battery of the electric-powered vehicle; determining, based on the amount of remaining battery, whether an amount of remaining battery of the electric-powered vehicle is no less than a predetermined value at the use start date and time; and transmitting, to the terminal, notification information indicating a result of the determining. For example, the determination includes calculating, based on a predetermined charging characteristic unique to a battery of the electric-powered vehicle, an amount of remaining battery to be held by the electric-powered vehicle at the use start date and time upon the electric-powered vehicle being charged at a charging station; and determining whether the amount of remaining battery of the electric-powered vehicle is no less than the predetermined value.

### CROSS REFERENCE TO RELATED APPLICATIONS

This is a continuation application of PCT International Application No. PCT/JP2020/016446 filed on Apr. 14, 2020, designating the United States of America, which is based on and claims priority of U.S. Provisional Patent Application No. 62/834,740 filed on Apr. 16, 2019. The entire disclosures of the above-identified applications, including the specifications, drawings and claims are incorporated herein by reference in their entirety.

### FIELD

The present disclosure relates to a control method, a control system, and a recording medium.

### BACKGROUND

For use in a charging management system for an electric-powered vehicle, such as an electric automobile, there exists a technique for improving the operation efficiency of a charger by use of boost charging (see PTL 1).

### CITATION LIST

### Patent Literature

PTL 1: Japanese Unexamined Patent Application Publication No. 2014-39409

### SUMMARY

### Technical Problem

However, there is still room for improvement in the operation efficiency of an electric-powered vehicle.

Accordingly, the present disclosure provides a control method and so on that improve the operation efficiency of an electric-powered vehicle.

### Solution to Problem

A control method according to one aspect of the present disclosure includes: obtaining, from a terminal, reservation information including a use start date and time of an electric-powered vehicle that a first user hopes to use at a future time; obtaining an amount of remaining battery of the electric-powered vehicle; determining, based on the amount of remaining battery obtained, whether an amount of remaining battery to be held by the electric-powered vehicle at the use start date and time included in the reservation information obtained is no less than a predetermined value; and transmitting, to the terminal, notification information indicating a result of the determining.

It is to be noted that general or specific aspects of the above may be implemented in the form of a system, an apparatus, an integrated circuit, a computer program, or a computer-readable recording medium, such as a CD-ROM, or through any desired combination of a system, an apparatus, an integrated circuit, a computer program, and a recording medium.

### Advantageous Effects

The control method according to the present disclosure improves the operation efficiency of an electric-powered vehicle.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating a configuration of a control system according to one exemplary embodiment.

FIG. 2 is a block diagram schematically illustrating a configuration of a server according to one exemplary embodiment.

FIG. 3 is a table illustrating an example of reservation information according to one exemplary embodiment.

FIG. 4 is a graph illustrating an example of a charging characteristic of a battery according to one exemplary embodiment.

FIG. 5 is a table illustrating an example of notification information according to one exemplary embodiment.

FIG. 6 is a flowchart illustrating a control method to be executed by a server according to one exemplary embodiment.

FIG. 7 is a diagram conceptually illustrating how a path is corrected according to one exemplary embodiment.

### DESCRIPTION OF EMBODIMENT

### (Underlying Knowledge Forming Basis of the Present Disclosure)

The present inventor has found the following problem with respect to the technique related to an electric-powered vehicle described in the Background section.

Electric-powered vehicles are widely used. An electric-powered bicycle is an example of such electric-powered vehicles. In the following section, some usage modes of electric-powered vehicles will be described with electric-powered bicycles serving as an example.

In one service mode related to electric-powered bicycles, electric-powered bicycles are managed by a service provider company and rented out to users each time the users use the electric-powered bicycles. In this mode, the electric-powered bicycles are charged at a charging station while they are not rented out. To use an electric-powered bicycle, a user, for example, walks to the charging station and starts using an electric-powered bicycle upon renting it at the charging station. When the user is to end the use of the electric-powered bicycle, the user travels to the charging station by the electric-powered bicycle and returns the electric-powered bicycle at the charging station. The electric-powered bicycle that is no longer being used by the user is recharged at the charging station.

When a service provider company takes a reservation for an electric-powered bicycle from a user who wants to use it at a future time, the electric-powered bicycle needs to be present at a charging station and have a sufficient amount of remaining battery at the time when the user starts using the electric-powered bicycle.

If the amount of remaining battery is not sufficient, the battery of the electric-powered bicycle may be depleted while the user is using the electric-powered bicycle, and the electric-powered bicycle may thus become inoperable. If, in order to prevent an electric-powered bicycle from becoming inoperable, a plenty of time is spent on charging the electric-powered bicycle at a charging station, this may create an unnecessarily extended period in which users cannot use the electric-powered bicycle, which may result in a decrease in the operation efficiency of the electric-powered bicycle. Such a decrease in the operation efficiency of an electric-powered bicycle in turn results in a decrease in the use efficiency of resources and a decrease in the power consumption efficiency.

In this manner, there is room for improvement in the operation efficiency of an electric-powered vehicle, such as an electric-powered bicycle.

Accordingly, the present disclosure provides a control method and so on that improve the operation efficiency of an electric-powered vehicle.

According to an exemplary embodiment disclosed herein, a control method includes obtaining, from a terminal, reservation information including a use start date and time of an electric-powered vehicle that a first user hopes to use at a future time; obtaining an amount of remaining battery of the electric-powered vehicle;

determining, based on the amount of remaining battery obtained, whether an amount of remaining battery to be held by the electric-powered vehicle at the use start date and time included in the reservation information obtained is no less than a predetermined value; and transmitting, to the terminal, notification information indicating a result of the determining.

According to the above aspect, the first user may be presented with the result of the determination as to whether the electric-powered vehicle to be used by the first user at a future time will have a sufficient amount of remaining battery at the time when the first user is to use the electric-powered vehicle. The first user can find whether he or she can be likely to start using the electric-powered vehicle at the use start date and time based on the presented result of the determination. If such a management is not performed, the electric-powered vehicle may have an insufficient amount of battery remaining when the first user hopes to start using the electric-powered vehicle, and the battery may be depleted while the first user is using the electric-powered vehicle, possibly making the electric-powered vehicle inoperable. As the first user is informed of the result of the determination as described above, the first user can use the electric-powered vehicle having a sufficient amount of remaining battery efficiently. Therefore, the control method according to one aspect of the present disclosure can improve the operation efficiency of an electric-powered vehicle.

The electric-powered vehicle may be being charged at a charging station when the reservation information is obtained. The determining may include (a) calculating, by use of a predetermined charging characteristic unique to a battery of the electric-powered vehicle, an amount of remaining battery to be held by the electric-powered vehicle at the use start date and time upon the electric-powered vehicle being charged at the charging station; and (b) determining whether the amount of remaining battery calculated of the electric-powered vehicle is no less than the predetermined value.

According to the above aspect, whether the amount of remaining battery of the electric-powered vehicle being charged at the charging station is no less than the predetermined value can be determined more simply and more accurately by use of the charging characteristic of the battery. Therefore, the control method according to one aspect of the present disclosure can improve the operation efficiency of an electric-powered vehicle by use of the determination that is based on a simpler and more accurate calculation.

The electric-powered vehicle may be being used by a second user different from the first user at a location different from a charging station when the reservation information is obtained. The determining may include (a) calculating a traveling time required for the electric-powered vehicle to travel to the charging station; (b) calculating, by use of a predetermined charging characteristic unique to a battery of the electric-powered vehicle, an amount of remaining battery to be held by the electric-powered vehicle at the use start date and time upon the electric-powered vehicle being charged at the charging station after traveling to the charging station; and (c) determining whether the amount of remaining battery calculated of the electric-powered vehicle is no less than the predetermined value.

According to the above aspect, whether the amount of remaining battery of the electric-powered vehicle being charged at the charging station is no less than the predetermined value can be determined more simply and more accurately by use of the traveling time of the bicycle and the charging characteristic of the battery. Therefore, the control method according to one aspect of the present disclosure can improve the operation efficiency of an electric-powered vehicle by use of the determination that is based on a simpler and more accurate calculation.

The reservation information may include path information indicating a first path along which the first user is to travel by the electric-powered vehicle. The predetermined value may be obtained by adding an amount of electric power required for the electric-powered vehicle to travel along the first path indicated by the path information to a lower limit value of an amount of remaining battery of the electric-powered vehicle.

According to the above aspect, since it suffices that the electric-powered vehicle be charged until the electric-powered vehicle has an amount of remaining battery necessary for the first user to use the electric-powered vehicle, the time it takes to charge the electric-powered vehicle can be reduced as compared to a case where the electric-powered vehicle is charged to have a more than necessary amount of remaining battery. Therefore, the time from when the second user ends the use of the electric-powered vehicle to when the first user starts using the electric-powered vehicle can be reduced, and in turn the operation efficiency of the electric-powered vehicle can be further improved. In this manner, the control method according to one aspect of the present disclosure can improve the operation efficiency of an electric-powered vehicle.

The control method may further include correcting the path information included in the reservation information obtained to path information indicating a second path from a starting station and passing through an en route station. The starting station may be a charging station in a use start location of a first electric-powered vehicle. The first electric-powered vehicle may be the electric-powered vehicle that the first user hopes to use. In the determining, when it is determined that (a) a second electric-powered vehicle different from the first electric-powered vehicle is located at the en route station and (b) an amount of remaining battery to be held by the second electric-powered vehicle when the first electric-powered vehicle has traveled from the starting station to the en route station along the second path is no less than a value obtained by adding an amount of electric power required for the second electric-powered vehicle to travel along a portion of the second path to be traveled by the second electric-powered vehicle past the en route station to a lower limit value of the amount of remaining battery of the second electric-powered vehicle, the determining may be performed by use of, as the predetermined value, a value obtained by adding an amount of electric power required for the first electric-powered vehicle to travel from the starting station to the en route station to the lower limit value of the amount of remaining battery of the first electric-powered vehicle.

According to the above aspect, since the path information corrected so that the first user can travel along the path by successively riding the first electric-powered vehicle and the second electric-powered vehicle is generated, the operation efficiency of the electric-powered vehicle can be further improved. In this manner, the control method according to one aspect of the present disclosure can improve the operation efficiency of an electric-powered vehicle.

When the amount of remaining battery of the electric-powered vehicle is obtained, an amount of remaining battery of each of a plurality of electric-powered vehicles may be obtained, and the plurality of electric-powered vehicles may each be the electric-powered vehicle. The determining may include identifying one or more electric-powered vehicles, among the plurality of electric-powered vehicles, that can be used at the use start date and time by performing the determining on each of the plurality of electric-powered vehicles. The notification information may include information indicating the one or more electric-powered vehicles identified.

According to the above aspect, since the information for identifying one or more electric-powered vehicles, among the plurality of electric-powered vehicles, that are to be used by the first user is provided, the first user can find the one or more electric-powered vehicles, among the plurality of electric-powered vehicles, that the first user can use. Then, the first user can use one electric-powered vehicle selected from the stated one or more electric-powered vehicles. Therefore, the control method according to one aspect of the present disclosure can improve the operation efficiency of an electric-powered vehicle while allowing the first user to select an electric-powered vehicle.

According to an exemplary embodiment disclosed herein, a control system includes a server and a charging station. The charging station includes charging equipment for charging an electric-powered vehicle. The server includes an obtainer, a determiner, and a notifier. The obtainer obtains, from a terminal, reservation information including a use start date and time of an electric-powered vehicle that a first user hopes to use at a future time, and obtains an amount of remaining battery of the electric-powered vehicle. The determiner makes a determination, based on the amount of remaining battery obtained, as to whether an amount of remaining battery of the electric-powered vehicle is no less than a predetermined value at the use start date and time included in the reservation information obtained. The notifier transmits, to the terminal, notification information indicating a result of the determination.

The above aspect provides advantageous effects similar to those of the control method described above.

According to an exemplary embodiment disclosed herein, a recording medium is a non-transitory computer-readable recording medium for use in a computer, and the recording medium has a computer program recorded thereon for causing the computer to execute the control method described above.

The above aspect provides advantageous effects similar to those of the control method described above.

It is to be noted that these general or specific aspects may be implemented in the form of a system, an apparatus, an integrated circuit, a computer program, or a computer-readable recording medium, such as a CD-ROM, or through any desired combination of a system, an apparatus, an integrated circuit, a computer program, and a recording medium.

Hereinafter, an exemplary embodiment will be described in concrete terms with reference to the drawings.

It is to be noted that the exemplary embodiment described below merely illustrates general or specific examples. The numerical values, the shapes, the materials, the constituent elements, the arrangement positions and the connection modes of the constituent elements, the steps, the orders of the steps, and so on illustrated in the following exemplary embodiment are examples and are not intended to limit the present disclosure. Among the constituent elements in the following exemplary embodiment, any constituent element that is not included in the independent claims expressing the broadest concept is to be construed as an optional constituent element.

### EMBODIMENT

According to the present embodiment, a control method and so on that improve the operation efficiency of an electric-powered vehicle will be described.

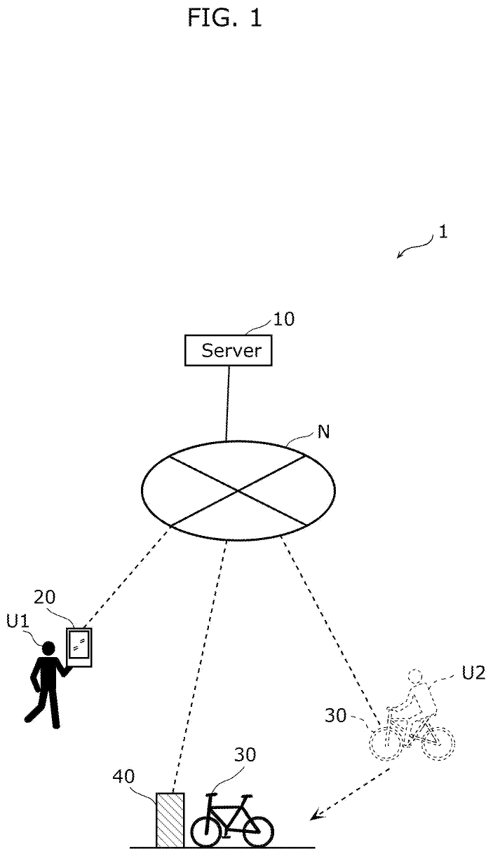

FIG. 1 is a block diagram schematically illustrating a configuration of control system 1 according to the present embodiment.

As illustrated in FIG. 1, control system 1 includes server 10 and station 40. Control system 1 is a system that controls the use of bicycle 30 by users including user U1.

User U1 owns terminal 20. Terminal 20 is a communication terminal including a communication interface, and examples of terminal 20 include a mobile phone or a smartphone. Terminal 20 is connected to and is capable of communicating with server 10 via network N. User U1 performs an operation such as reserving bicycle 30 by use of terminal 20. User U1 is an example of a user who is not using bicycle 30 at the present time and is hoping to use bicycle 30 at a future time.

Bicycle 30 is a bicycle whose use is controlled by control system 1. Bicycle 30 is an electric-powered bicycle, which is an example of an electric-powered vehicle. Bicycle 30 includes a rechargeable battery (a secondary battery). Bicycle 30 is ridden by any one of a plurality of users including user U1 and travels as electric power supplied from the battery actuates its wheels. The battery of bicycle 30 can be charged at station 40. In this example, the charging of the battery of bicycle 30 may simply be phrased as the charging of bicycle 30.

Bicycle 30 includes a communication interface and may be connected to and be capable of communicating with station 40. Bicycle 30 further includes a processor and a memory. Bicycle 30 performs information processing as the processor executes a predetermined program by use of the memory. Bicycle 30 may obtain its position information by use of the Global Positioning System (GPS) or the like. In this example, the communication interface included in bicycle 30 may be connected to and be capable of communicating with server 10 via network N. In this case, the communication interface included in bicycle 30 may be a long-distance wireless communication interface that can connect to a mobile phone carrier network. Alternatively, the communication interface included in bicycle 30 may be a short-distance wireless communication interface, such as a Wi-Fi (registered trademark) interface or a Bluetooth (registered trademark) interface. In a case where the communication terminal included in bicycle 30 is a short-distance wireless communication interface, bicycle 30 can connect to network N via a communication terminal that is owned by user U1 using bicycle 30 and that includes a long-distance wireless communication interface, for example. In this example, instead of bicycle 30, other types of electric-powered vehicles such as an electric-powered automobile, an electric-powered scooter, or an electric-powered kickboard can also be used.

Station 40 is a charging station for charging bicycle 30. Station 40 is provided with charging equipment for charging bicycle 30. Station 40 connects the charging equipment to bicycle 30 and charges bicycle 30 by supplying electric power to the battery of bicycle 30. One or more bicycles 30 may be placed at station 40, and station 40 can charge one or more bicycles 30. Station 40 is connected to and is capable of communicating with bicycle 30 and obtains the amount of remaining battery of bicycle 30 connected to station 40. Station 40 obtains the amount of remaining battery of each of one or more bicycles 30 placed at station 40 and transmits the obtained amount of remaining battery to server 10.

Server 10 is a control device that controls the use of bicycle 30 by user U1 and so on. Specifically, server 10 manages the user or users of bicycle 30 by time. Upon receiving a reservation from user U1 for the use of bicycle 30, server 10 controls bicycle 30 so that user U1 can use bicycle 30 in accordance with the reservation.

Specifically, if there is bicycle 30 at station 40 when user U1 hopes to use bicycle 30, server 10 controls bicycle 30 such that user U1 can use that bicycle 30, upon determining that the amount of remaining battery of that bicycle 30 is no less than the amount of electric power to be used by user U1. The processes of server 10 will be described later in detail.

In the following description, it is assumed that user U1 is hoping to use bicycle 30 at a future time.

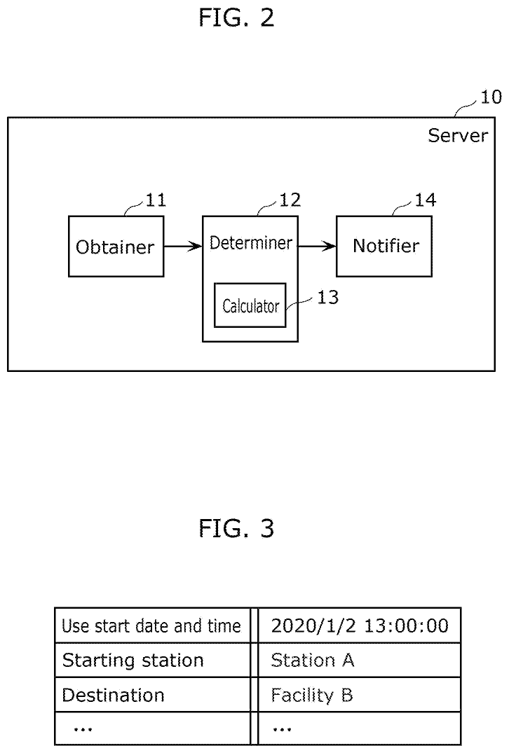

FIG. 2 is a block diagram schematically illustrating a configuration of server 10 according to the present embodiment.

As illustrated in FIG. 2, server 10 includes obtainer 11, determiner 12, and notifier 14. Each functional unit included in server 10 may be implemented as a central processing unit (CPU) (not illustrated) included in server 10 executes a predetermined program by use of a memory.

Obtainer 11 is a functional unit that obtains various pieces of information related to a reservation for bicycle 30. Specifically, obtainer 11 obtains reservation information and an amount of remaining battery.

The reservation information obtained by obtainer 11 includes at least a use start date and time at which user U1 hopes to start using bicycle 30 at a future time. The reservation information is transmitted by terminal 20.

The amount of remaining battery obtained by obtainer 11 is the amount of battery remaining at the present time of bicycle 30. This amount of remaining battery may, for example, be obtained by station 40 from bicycle 30, and station 40 may transmit the obtained amount of remaining battery to server 10. Alternatively, the amount of remaining battery may be transmitted by bicycle 30 via network N. In a case where there are one or more bicycles 30, obtainer 11 obtains the amount of remaining battery from each of one or more bicycles 30. The amount of remaining battery described above is information obtained by measuring the amount of battery remaining in the battery of bicycle 30. As “the amount of battery remaining at the present time”, the amount of remaining battery obtained by measuring the amount of battery remaining within a predetermined time (e.g., ten minutes) spanning from the present time to a predetermined time in the past can be used.

Determiner 12 is a functional unit that makes a determination regarding the amount of remaining battery of bicycle 30. Determiner 12 determines whether the amount of remaining battery of bicycle 30 will be no less than a predetermined value at the use start date and time included in the reservation information obtained by obtainer 11. Determiner 12 calculates, by use of calculator 13, the amount of remaining battery of bicycle 30 to be held at the time when user U1 hopes to use bicycle 30. Then, determiner 12 makes the determination described above based on the amount of remaining battery calculated by calculator 13. Determiner 12 determines whether bicycle 30 is being charged at station 40 or is being used by another user (referred to as user U2) at the time when obtainer 11 has obtained the reservation information. Based on the result of this determination, calculator 13 calculates the amount of remaining battery.

If determiner 12 has determined that bicycle 30 is being charged at station 40 at the time when obtainer 11 has obtained the reservation information, calculator 13 calculates, by use of a predetermined charging characteristic unique to the battery of bicycle 30, the amount of battery to remain in bicycle 30 at the use start date and time upon bicycle 30 being charged at station 40.

Meanwhile, if determiner 12 has determined that bicycle 30 is being used by user U2 at a location different from station 40 at the time when obtainer 11 has obtained the reservation information, calculator 13 calculates the time it takes for bicycle 30 to travel to station 40. Furthermore, calculator 13 calculates, by use of the predetermined charging characteristic unique to the battery of bicycle 30, the amount of battery to remain in bicycle 30 at the use start date and time upon bicycle 30 being charged at station 40 after bicycle 30 has traveled to station 40. The time it takes for bicycle 30 to travel to station 40 may be calculated by calculating, by use of map information, the distance to station 40 from the current position indicated by the position information obtained by bicycle 30 and calculated by use of the calculated distance and the mean traveling speed of bicycle 30.

In this example, if there are a plurality of bicycles 30 to deal with, determiner 12 may identify bicycle 30, among the plurality of bicycles 30, whose amount of remaining battery will be no less than a predetermined value at the use start date and time included in the reservation information obtained by obtainer 11. In this case, obtainer 11 obtains the amount of remaining battery of each of the plurality of bicycles 30. Then, determiner 12 determines whether the amount of remaining battery will be no less than the predetermined value at the use start date and time for each of the plurality of bicycles 30. Based on this determination, determiner 12 identifies bicycle 30 or bicycles 30 whose amount of remaining battery will be no less than the predetermined value at the use start date and time as one or more bicycles that can be used at the use start date and time.

Notifier 14 is a functional unit that transmits, to terminal 20, notification information indicating the result of the determination made by determiner 12. The notification information transmitted to terminal 20 may be presented to user U1 as the notification information is displayed on a display screen or the like of terminal 20.

In this example, the reservation information to be obtained by obtainer 11 may include path information indicating a path along which user U1 travels by bicycle 30. In this case, the predetermined value that determiner 12 uses to make a determination regarding the amount of remaining battery is calculated by adding the amount of electric power required for bicycle 30 to travel along the path indicated by the path information to a lower limit value of the amount of remaining battery of bicycle 30. The path information includes, for example, information indicating a destination or information indicating a destination and a location en route to the destination. In a case where the path information includes information indicating a destination, the path indicated by the path information is the path along which user U1 travels by bicycle 30 from a starting station to the destination and then travels back from the destination to the starting station. In a case where the path information includes information indicating a destination and a location en route to the destination, the path indicated by the path information is the path along which user U1 travels by bicycle 30 between a starting station and the destination via the location indicated by the path information either on the way from the starting station to the destination or on the way from the destination to the starting station. In this example, there may be a plurality of such locations on the route.

Moreover, the path information may include a charging station where bicycle 30 can be charged and that is present along the path described above (i.e., an en route station). A case where a path that includes an en route station is used will be described later in detail.

FIG. 3 is a table illustrating an example of the reservation information according to the present embodiment.

As illustrated in FIG. 3, the reservation information includes the use start date and time, the starting station, and the destination. In this example, the starting station and the destination are optional.

The use start date and time is the date and time at which user U1 hopes to start using bicycle 30. User U1 intends to start using bicycle 30 at the point in time indicated by the use start date and time.

The starting station provides information indicating a charging station where user U1 hopes to start using bicycle 30. The starting station can be indicated in any format as long as that information allows the charging station to be identified on a map. For example, information indicating the name or the position (e.g., the latitude, the longitude, the floor number, or the like) of a facility can be used.

The destination provides information indicating the destination to which user U1 is to travel by bicycle 30. The destination can be indicated in any format as long as that information allows the destination to be identified on a map. For example, information indicating the name or the position (e.g., the latitude, the longitude, the floor number, or the like) of a facility can be used. The destination is an example of the path information indicating the path along which user U1 travels by bicycle 30.

The reservation information illustrated in FIG. 3 is an example of the reservation information based on which user U1 is to start using bicycle 30 at the use start date and time of “Jan. 2, 2020, at 13:00”, which is a future date and time. This reservation information also indicates that user U1 starts using bicycle 30 at station A and the destination is facility B. In other words, the reservation information indicates that user U1 is to use bicycle 30 to make a round trip between station A and facility B.

FIG. 4 is a graph illustrating an example of a charging characteristic of a battery according to the present embodiment. The charging characteristic illustrated in FIG. 4 is an example of a predetermined charging characteristic unique to the battery of bicycle 30.

The charging characteristic illustrated in FIG. 4 indicates a change in the amount of remaining battery (the vertical axis) with respect to the charging time (the horizontal axis) of the battery observed when the battery is being charged.

If the battery having the charging characteristic illustrated in FIG. 4 has the amount of remaining battery of B1 at time T1, for example, the battery will have the amount of remaining battery of B2 at time T2 upon being charged. The time it takes for the amount of remaining battery to change from B1 to B2 is T.

When calculating the amount of battery to remain in bicycle 30 at the use start date and time by use of the charging characteristic of the battery, calculator 13 calculates amount B2 of battery to remain at the use start date and time by using the time at which obtainer 11 has obtained the reservation information as T1 in FIG. 4, the amount of remaining battery at that time as B1 in FIG. 4, and the use start date and time as T2 in FIG. 4.

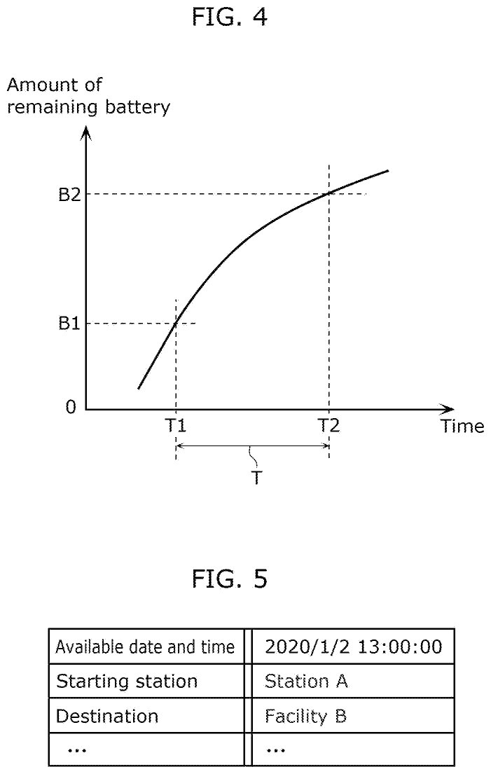

FIG. 5 is a table illustrating an example of the notification information according to the present embodiment.

As illustrated in FIG. 5, the notification information includes the available date and time, the starting station, and the destination. In this example, the starting station and the destination are optional.

The available date and time provides information indicating the date and time at which user U1 can start using bicycle 30. The use start date and time included in the reservation information is set in the available date and time.

The starting station provides information indicating a charging station where user U1 is to start using bicycle 30. The starting station in the reservation information (see FIG. 3) is set in this starting station.

The destination provides information indicating the destination to which user U1 travels by bicycle 30. The destination is an example of the path information. The destination in the reservation information (see FIG. 3) is set in this destination. In this example, the path information may include the destination in the reservation information and be corrected to the path information indicating a path that includes an en route station. The process to be performed in that case will be described later in detail.

The process of server 10 configured as described above will now be described.

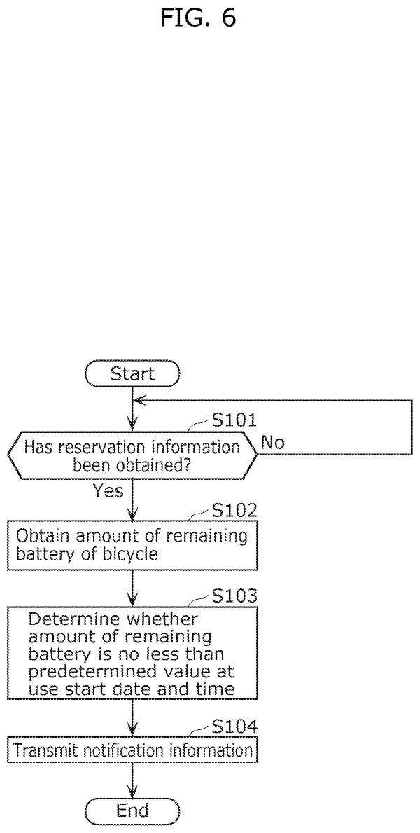

FIG. 6 is a flowchart illustrating a control method to be executed by server 10 according to the present embodiment.

At step S101, obtainer 11 determines whether obtainer 11 has obtained reservation information from terminal 20 of user U1. If obtainer 11 has obtained the reservation information (Yes at step S101), the process proceeds to step S102. If obtainer 11 has not received the reservation information (No at step S101), obtainer 11 executes step S101 again. In other words, obtainer 11 remains in a standby state at step S101 until obtainer 11 obtains the reservation information.

At step S102, obtainer 11 obtains the amount of remaining battery of bicycle 30 located at station 40.

At step S103, based on the amount of remaining battery obtained at step S102, determiner 12 determines whether the amount of remaining battery of bicycle 30 will be no less than the predetermined value at the use start date and time included in the reservation information obtained at step S101.

At step S104, notifier 14 transmits the notification information indicating the result of the determination made at step S103 to terminal 20.

Through the series of processes illustrated in FIG. 6, server 10 can improve the operation efficiency of bicycle 30.

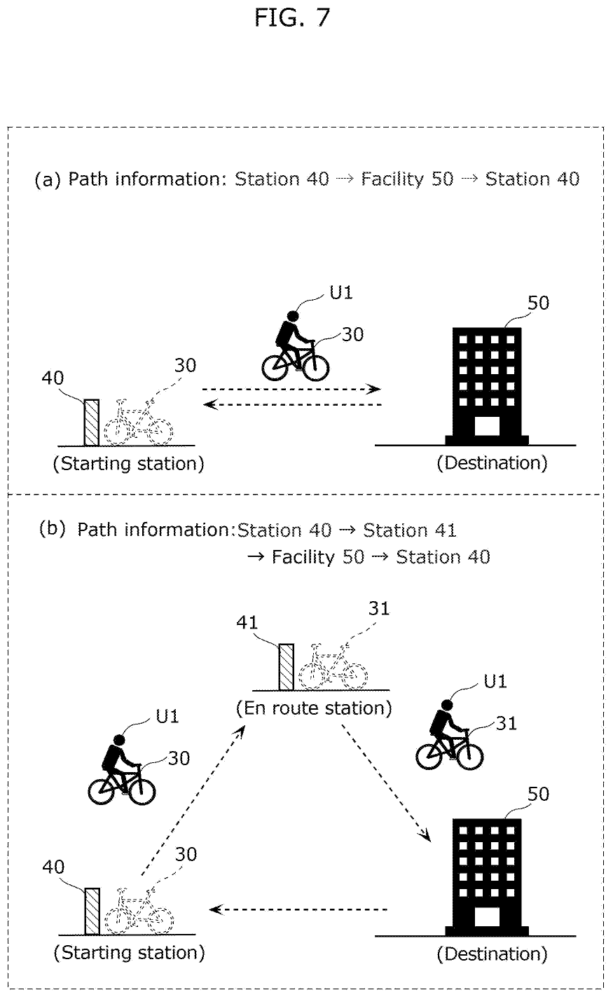

In this example, even in a case where the amount of remaining battery of bicycle 30 will be less than the predetermined value at the use start date and time, if user U1 uses a plurality of bicycles 30 successively, user U1 can still use the bicycle as desired. The process that server 10 performs in this case will be described with reference to FIG. 7.

FIG. 7 is a diagram conceptually illustrating how a path is corrected according to the present embodiment.

In (a) in FIG. 7, path information of bicycle 30 that user U1 is hoping to use is illustrated. This path information corresponds to the path information included in the reservation information that obtainer 11 obtains from terminal 20.

Specifically, the path information illustrated in (a) in FIG. 7 indicates a path along which user U1 travels from station 40 serving as the starting station to facility 50 serving as the destination and then travels back from facility 50 serving as the destination to station 40 serving as the starting station.

In a case where the amount of remaining battery of bicycle 30 is no less than the predetermined value at the use start date and time included in the reservation information, this bicycle 30 is managed as bicycle 30 that user U1 is to use.

Meanwhile, in a case where the amount of remaining battery of bicycle 30 will be less than the predetermined value at the use start date and time included in the reservation information, if user U1 starts using bicycle 30 at the use start date and time, the battery of bicycle 30 may be depleted while user U1 is using bicycle 30, and bicycle 30 may become inoperable.

In this case, calculator 13 corrects the path information (see (a) in FIG. 7) included in the reservation information obtained by obtainer 11 to the path information illustrated in (b) in FIG. 7. This operation allows user U1 to use bicycle 30 as desired.

The path information illustrated in (b) in FIG. 7 indicates a path along which user U1 travels by bicycle 30 from station 40 serving as the starting station to station 41 serving as an en route station and then travels by bicycle 31 from station 41 to station 40 via facility 50 serving as the destination.

In other words, calculator 13 corrects the path information included in the reservation information obtained by obtainer 11 to path information indicating a second path along which user U1 travels from the starting station that is a charging station in the use start location of bicycle 30 (corresponding to a first electric-powered vehicle) that user U1 hopes to use to the destination via an en route station. Then, if determiner 12 has determined that (a) bicycle 31 (corresponding to a second electric-powered vehicle) different from bicycle 30 is located at the en route station and (b) the amount of battery to remain in bicycle 31 when bicycle 30 has traveled from the starting station to the en route station along the second path will be no less than a value obtained by adding the amount of electric power required for bicycle 31 to travel along a portion of the second path to be traveled by bicycle 31 past the en route station to a lower limit value of the amount of remaining battery of bicycle 31, determiner 12 makes a determination by using, as the predetermined value, the value obtained by adding the amount of electric power required for bicycle 30 to travel from the starting station to the en route station to a lower limit value of the amount of remaining battery of bicycle 30.

In this case, determiner 12 determines whether bicycle 31 is located at station 41. In addition, determiner 12 determines whether the amount of battery to remain in bicycle 31 when bicycle 30 has traveled to station 41 has the amount of electric power required for bicycle 31 to travel from station 41 to station 40 via facility 50. Then, if determiner 12 has determined that bicycle 31 is located at station 41 and that the amount of battery to remain in bicycle 31 at the time stated above has the amount of electric power required for bicycle 31 to travel from station 41 to station 40 via facility 50, determiner 12 sets the predetermined value to be used in the determination as follows. In other words, in this case, determiner 12 uses, as the predetermined value, the value obtained by adding the amount of electric power required for bicycle 30 to travel from the starting station to the en route station to the lower limit value of the amount of remaining battery of bicycle 30.

With this configuration, user U1 can travel from the starting station to the destination by riding bicycle 30 and bicycle 31 successively and then travel along the path leading back to the starting station.

In this example, server 10 may manage the reservation information obtained from terminal 20 and information such as the amount of remaining battery obtained from bicycle 30 by use of a distributed ledger. In this case, server 10 is implemented by a plurality of servers each including a distributed ledger. Information such as the reservation information or the amount of remaining battery is stored in the distributed ledger in the form of transaction data, and the transaction data described above is managed so as not to be altered, based on the characteristic that information recorded in a distributed ledger is hard to alter.

In this example, the distributed ledger is, for example, a blockchain, and this case will be described as an example. Alternatively, a distributed ledger of a different scheme (e.g., IOTA, Hashgraph, or the like) can also be employed. The distributed ledger may or may not execute a consensus algorithm (e.g., Practical Byzantine Fault Tolerance (PBFT), Proof of Work (PoK), or Proof of Stake (PoS)) at the time of storing new data. Hyperledger fabric is an example of the distributed ledger technology that does not execute a consensus algorithm.

As described above, with the control method according to the present embodiment, the first user may be presented with the result of the determination as to whether the electric-powered vehicle to be used by the first user at a future time will have a sufficient amount of remaining battery at the time when the first user is to use the electric-powered vehicle. The first user can find whether he or she can be likely to start using the electric-powered vehicle at the use start date and time based on the presented result of the determination. If such a management is not performed, the electric-powered vehicle may have an insufficient amount of battery remaining when the first user hopes to start using the electric-powered vehicle, and the battery may be depleted while the first user is using the electric-powered vehicle, possibly making the electric-powered vehicle inoperable. As the first user is informed of the result of the determination as described above, the first user can use the electric-powered vehicle having a sufficient amount of remaining battery efficiently. Therefore, the control method according to one aspect of the present disclosure can improve the operation efficiency of an electric-powered vehicle.

Moreover, whether the amount of remaining battery of the electric-powered vehicle being charged at the charging station is no less than the predetermined value can be determined more simply and more accurately by use of the charging characteristic of the battery. Therefore, the control method according to one aspect of the present disclosure can improve the operation efficiency of an electric-powered vehicle by use of the determination that is based on a simpler and more accurate calculation.

Moreover, whether the amount of remaining battery of the electric-powered vehicle being charged at the charging station is no less than the predetermined value can be determined more simply and more accurately by use of the traveling time of the bicycle and the charging characteristic of the battery. Therefore, the control method according to one aspect of the present disclosure can improve the operation efficiency of an electric-powered vehicle by use of the determination that is based on a simpler and more accurate calculation.

Moreover, since it suffices that the electric-powered vehicle be charged until the electric-powered vehicle has an amount of remaining battery necessary for the first user to use the electric-powered vehicle, the time it takes to charge the electric-powered vehicle can be reduced as compared to a case where the electric-powered vehicle is charged to have a more than necessary amount of remaining battery. Therefore, the time from when the second user ends the use of the electric-powered vehicle to when the first user starts using the electric-powered vehicle can be reduced, and in turn the operation efficiency of the electric-powered vehicle can be further improved. In this manner, the control method according to one aspect of the present disclosure can improve the operation efficiency of an electric-powered vehicle.

Moreover, since the path information corrected so that the first user can travel along the path by successively riding the first electric-powered vehicle and the second electric-powered vehicle is generated, the operation efficiency of the electric-powered vehicle can be further improved. In this manner, the control method according to one aspect of the present disclosure can improve the operation efficiency of an electric-powered vehicle.

Moreover, since the information for identifying one or more electric-powered vehicles, among the plurality of electric-powered vehicles, that are to be used by the first user is provided, the first user can find the one or more electric-powered vehicles, among the plurality of electric-powered vehicles, that the first user can use. Then, the first user can use one electric-powered vehicle selected from the stated one or more electric-powered vehicles. Therefore, the control method according to one aspect of the present disclosure can improve the operation efficiency of an electric-powered vehicle while allowing the first user to select an electric-powered vehicle.

In the foregoing embodiments, the constituent elements may each be implemented by dedicated hardware or may each be implemented through the execution of a software program suitable for the corresponding constituent element. The constituent elements may each be implemented as a program executing unit, such as a CPU or a processor, reads out a software program recorded on a recording medium, such as a hard disk or a semiconductor memory, and executes the software program. Herein, the software that implements the control method and so on of the foregoing embodiments is a program such as the one described below.

Specifically, this program causes a computer to execute a control method that includes obtaining, from a terminal, reservation information including a use start date and time of an electric-powered vehicle that a first user hopes to use at a future time; obtaining an amount of remaining battery of the electric-powered vehicle; determining, based on the amount of remaining battery obtained, whether an amount of remaining battery to be held by the electric-powered vehicle at the use start date and time included in the reservation information obtained is no less than a predetermined value; and transmitting, to the terminal, notification information indicating a result of the determining.

Thus far, the control system and so on according to one or more aspects have been described based on the embodiment, but the present disclosure is not limited to this embodiment. Unless departing from the spirit of the present disclosure, an embodiment obtained by making various modifications that are conceivable by a person skilled in the art to the present embodiment or an embodiment obtained by combining the constituent elements in different embodiments may also be included within the scope of the one or more aspects.

### INDUSTRIAL APPLICABILITY

The present disclosure can be used in a control system that manages the use of an electric-powered vehicle.

1. A control method, comprising:
obtaining, from a terminal, reservation information including a use start date and time of an electric-powered vehicle that a first user hopes to use at a future time;
obtaining an amount of remaining battery of the electric-powered vehicle;
determining, based on the amount of remaining battery obtained, whether an amount of remaining battery to be held by the electric-powered vehicle at the use start date and time included in the reservation information obtained is no less than a predetermined value; and
transmitting, to the terminal, notification information indicating a result of the determining.

2. The control method according to claim 1, wherein
the electric-powered vehicle is being charged at a charging station when the reservation information is obtained, and
the determining includes:
(a) calculating, by use of a predetermined charging characteristic unique to a battery of the electric-powered vehicle, an amount of remaining battery to be held by the electric-powered vehicle at the use start date and time upon the electric-powered vehicle being charged at the charging station; and
(b) determining whether the amount of remaining battery calculated to be held by the electric-powered vehicle is no less than the predetermined value.

3. The control method according to claim 1, wherein
the electric-powered vehicle is being used by a second user different from the first user at a location different from a charging station when the reservation information is obtained, and
the determining includes:
(a) calculating a traveling time required for the electric-powered vehicle to travel to the charging station;
(b) calculating, by use of a predetermined charging characteristic unique to a battery of the electric-powered vehicle, an amount of remaining battery to be held by the electric-powered vehicle at the use start date and time upon the electric-powered vehicle being charged at the charging station after traveling to the charging station; and
(c) determining whether the amount of remaining battery calculated to be held by the electric-powered vehicle is no less than the predetermined value.

4. The control method according to claim 1, wherein
the reservation information includes path information indicating a first path along which the first user is to travel by the electric-powered vehicle, and
the predetermined value is calculated by adding an amount of electric power required for the electric-powered vehicle to travel along the first path indicated by the path information to a lower limit value of an amount of remaining battery of the electric-powered vehicle.

5. The control method according to claim 4, further comprising:
correcting the path information included in the reservation information obtained to path information indicating a second path from a starting station and passing through an en route station, the starting station being a charging station in a use start location of a first electric-powered vehicle, the first electric-powered vehicle being the electric-powered vehicle that the first user hopes to use, wherein
in the determining,
when it is determined that
(a) a second electric-powered vehicle different from the first electric-powered vehicle is located at the en route station and
(b) an amount of remaining battery to be held by the second electric-powered vehicle when the first electric-powered vehicle has traveled from the starting station to the en route station along the second path is no less than a value obtained by adding an amount of electric power required for the second electric-powered vehicle to travel along a portion of the second path to be traveled by the second electric-powered vehicle past the en route station to a lower limit value of the amount of remaining battery of the second electric-powered vehicle,
the determining is performed by use of, as the predetermined value, a value obtained by adding an amount of electric power required for the first electric-powered vehicle to travel from the starting station to the en route station to the lower limit value of the amount of remaining battery of the first electric-powered vehicle.

6. The control method according to claim 1, wherein
when the amount of remaining battery of the electric-powered vehicle is obtained, an amount of remaining battery of each of a plurality of electric-powered vehicles is obtained, the plurality of electric-powered vehicles each being the electric-powered vehicle,
the determining includes identifying one or more electric-powered vehicles, among the plurality of electric-powered vehicles, that can be used at the use start date and time by performing the determining on each of the plurality of electric-powered vehicles, and
the notification information includes information indicating the one or more electric-powered vehicles identified.

7. A control system, comprising:
a server; and
a charging station, wherein
the charging station includes charging equipment for charging an electric-powered vehicle, and
the server includes:
an obtainer that obtains, from a terminal, reservation information including a use start date and time of an electric-powered vehicle that a first user hopes to use at a future time, and obtains an amount of remaining battery of the electric-powered vehicle;
a determiner that makes a determination, based on the amount of remaining battery obtained, as to whether an amount of remaining battery to be held by the electric-powered vehicle at the use start date and time included in the reservation information obtained is no less than a predetermined value; and
a notifier that transmits, to the terminal, notification information indicating a result of the determination.

8. A non-transitory computer-readable recording medium for use in a computer, the recording medium having a computer program recorded thereon for causing the computer to execute the control method according to claim 1.
